(19) United States
(12) Patent Application Publication
(10) Pub. No.: US 2003/0212597 A1
(43) Pub. Date: Nov. 13, 2003

(54) Multi-level point accumulation for a player tracking system and method

(75) Inventor: Richard I. Ollins, Las Vegas, NV (US)

Correspondence Address: BEYER WEAVER & THOMAS LLP, P.O. BOX 778, BERKELEY, CA, 94704-0778, US

(73) Assignee: IGT

(21) Appl. No.: 10/144,139

(22) Filed: May 10, 2002

(51) Int. Cl. G06F 17/60

(52) U.S. Cl. 705/14

(57) ABSTRACT

A player tracking system and method for tracking the customer activity of a plurality of customers at one or more casino establishments. The system includes an account manager device having a first customer account associated with a first customer and a second customer account associated with a second customer, in which the second customer is sponsored by the first customer. Each customer account includes an associated customer Identification (ID) and a respective accumulated point total. A monitoring device is configured to monitor the betting activity of the plurality of customers at the one or more casino establishments, and a point accumulation device is adapted to accrue primary betting activity points for the customer accounts, based upon their monitored betting activity. The point accumulation device is further adapted to accrue sponsorship points for sponsors of new accounts which may also be applied toward the accumulated point total. Thus, multi-level point accumulation is provided to encourage further patronage.

### BACKGROUND OF THE INVENTION

The present invention relates generally to player tracking services one gaming machines, and more particularly, relates to multi-level point accumulation for player tracking systems.

There are a wide variety of associated devices that can be connected to a gaming machine such as a slot machine or video poker machine. Some examples of these devices are player tracking interfaces, lights, ticket printers, card readers, speakers, bill validators, ticket readers, coin acceptors, display panels, key pads, coin hoppers and button pads. Many of these devices are built into the gaming machine or components associated with the gaming machine such as a top box which usually sits on top of the gaming machine.

Typically, utilizing a master gaming controller, the gaming machine controls various combinations of devices that allow a player to play a game on the gaming machine and also encourage game play on the gaming machine. For example, a game played on a gaming machine usually requires a player to input money or indicia of credit into the gaming machine, indicate a wager amount, and initiate a game play. These steps require the gaming machine to control input devices, including bill validators and coin acceptors, to accept money into the gaming machine and recognize user inputs from devices, including touch screens and button pads, to determine the wager amount and initiate game play.

After game play has been initiated, the gaming machine determines a game outcome, presents the game outcome to the player and may dispense an award of some type depending on the outcome of the game. A game outcome presentation may utilize many different visual and audio components such as flashing lights, music, sounds and graphics. The visual and audio components of the game outcome presentation may be used to draw a players attention to various game features and to heighten the players interest in additional game play. Maintaining a game player's interest in game play, such as on a gaming machine or during other gaming activities, is an important consideration for an operator of a gaming establishment.

One related method of attaining and/or maintaining a game player's interest in game play are player tracking programs which are offered at various casinos. Player tracking programs provide rewards to players that typically correspond to the player's level of patronage (e.g., to the player's playing frequency and/or total amount of game plays at a given casino). Player tracking rewards may include free meals, free lodging and/or free entertainment. These rewards may help to sustain a game player's interest in additional game play during a visit to a gaming establishment and may entice a player to visit a gaming establishment to partake in various gaming activities.

In general, player tracking programs may be applied to any game of chance offered at a gaming establishment. In particular, player tracking programs are very popular with players of mechanical slot gaming machines and video slot gaming machines. In a gaming machine, a player tracking program is implemented using a player tracking unit installed in the gaming machine and in communication with a remote player tracking/accounting server.

Due to their increasing popularity, player tracking cards and player tracking programs have essentially become the de facto marketing method of doing business at casinos. As suggested above, a player's incentive for using the player tracking services is awards provided by the gaming machine operator (e.g., the casino). Some incentives of a casino for providing player tracking services is to generate “brand” loyalty, gather valuable information that may be used for marketing and provide better customer services. This is due to the fact that the programs allow a casino to identify and reward customers based upon their previous game play history. In particular, a goal of the casinos is to identify and then to provide a higher level of service to certain groups of players identified as especially valuable to the casinos.

Gaming establishments are continually searching for new and innovative techniques to track patron activity to improve casino operations and marketing. Thus, while these current tracking systems are adequate, they are limited mainly to gaming play and Point-Of-Sales events. It would be desirable, accordingly, to provide an apparatus and method for player tracking programs that allow the casinos to expand such player tracking to include all casino activity.

### SUMMARY OF THE INVENTION

The present invention provides a computer-implemented apparatus and method for tracking the customer activity of a plurality of customers at one or more casino establishments. The method, for instance, includes creating a first customer account having a customer Identification (ID) associated with a first customer, and creating a second customer account having a customer Identification (ID) associated with a second customer, wherein the second customer is sponsored by the first customer. The method includes monitoring the betting activity of the first customer at the one or more casino establishments. In response to the detection of such betting activity, accruing primary betting activity points in the first customer account. These primary betting activity points relate to the betting activity of the first customer monitored at the one or more casino establishments. The method further includes accruing sponsorship points in the first customer account based upon the sponsorship of the second customer by the first customer; and providing at least one of complementaries and services to the customers based upon their accumulated point total.

Accordingly, not only are player tracking points accumulated for the gaming activity monitored and detected for each player, but player tracking points are also accumulated for customers sponsoring new customers for player tracking. Such sponsorship encourages their existing customers to enroll new members, which of course also benefits casino establishment by inciting greater betting activity.

The betting activity of the second customer may be monitored at the one or more casino establishments as well. Primary betting activity points hence would be accrued in the second customer account which relate to their corresponding betting activity. In one specific embodiment, secondary betting activity points may be accrued in the first customer account, based upon their sponsorship of the second customer, which relates to the primary betting activity points accrued in the second customer account.

In one embodiment, the secondary betting activity points accrued in the first customer account are proportional to the primary betting activity points accrued in the second customer account.

According to yet another specific embodiment, a third customer account may be created having a respective customer Identification (ID) associated with a third customer. In this example, the third customer may be sponsored by the second customer. Thus, sponsorship points may be accrued in the second customer account based upon the sponsorship of the third customer by the second customer. Moreover, sponsorship points in the first customer account may also be accrued based upon the sponsorship of the second customer by the first customer, and upon the sponsorship of the third customer by the second customer.

The betting activity of the third customer may also be monitored at the one or more casino establishments. Thus, primary betting activity points may be accrued in the third customer account relating to the betting activity of the third customer monitored at the one or more casino establishments. Similar to the embodiment above-mentioned, secondary betting activity points are accrued in the second customer account relating to the primary betting activity points accrued in the third customer. Further, tertiary betting activity points are accrued in the first customer account relating to the secondary betting activity accrued in the second customer account.

In another aspect of the present invention, a player tracking system is provided for tracking the customer activity of a plurality of customers at one or more casino establishments. The system includes an account manager device having a first customer account associated with a first customer and a second customer account associated with a second customer, in which the second customer is sponsored by the first customer. Each customer account having an associated customer Identification (ID) and a respective accumulated point total. A monitoring device is configured to monitor the betting activity of the plurality of customers at the one or more casino establishments, and a point accumulation device is adapted to accrue primary betting activity points for the customer accounts, based upon their monitored betting activity. The point accumulation device is further adapted to accrue sponsorship points for sponsors of new accounts which may also be applied toward the accumulated point total. Thus, multi-level point accumulation is provided to encourage further patronage.

### BRIEF DESCRIPTION OF THE DRAWINGS

The assembly of the present invention has other objects and features of advantage which will be more readily apparent from the following description of the best mode of carrying out the invention and the appended claims, when taken in conjunction with the accompanying drawing, in which:

FIG. 1 is a block diagram of a player tracking system constructed in accordance with the present invention.

FIG. 2 is a block diagram of the components of the player tracking interface of the player tracking system of FIG. 1.

FIG. 3 is a flow diagram of a method for multi-level point distribution in accordance with the present invention.

### DESCRIPTION OF THE PREFERRED EMBODIMENTS

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims. It will be noted here that for a better understanding, like components are designated by like reference numerals throughout the various figures.

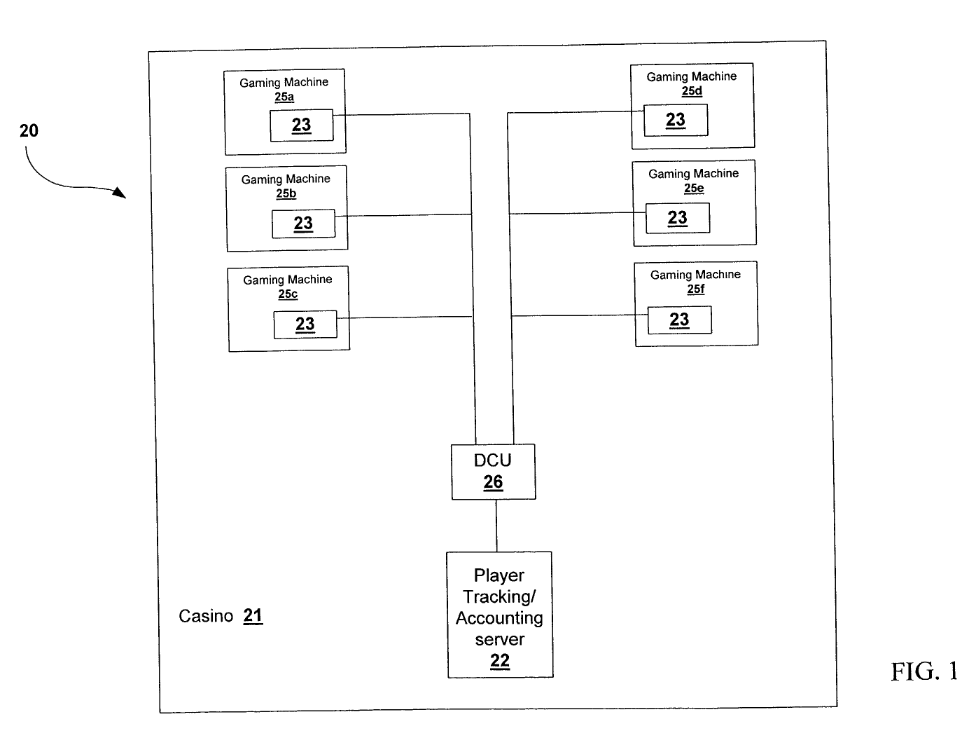

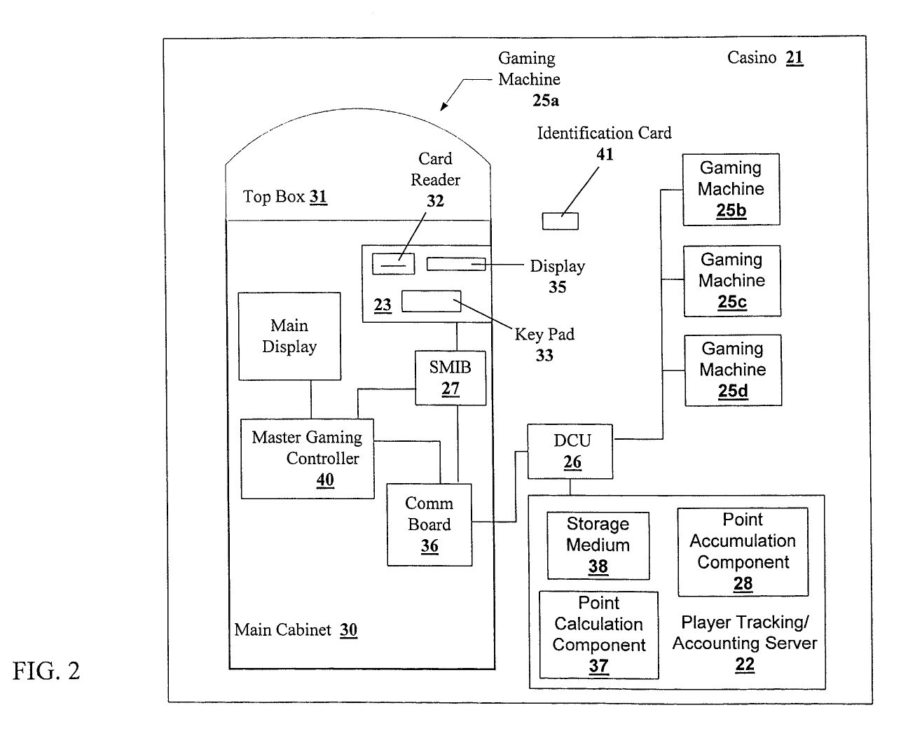

Attention is now directed to FIGS. 1 and 2 where a player tracking system, generally designated 20, is illustrated for tracking customer activity for a plurality of customers at one or more casino establishments 21. The system includes an account manager device 22 having a first customer account associated with a first customer and a second customer account associated with a second customer, in which the second customer is sponsored by or an associate of the first customer. Each customer account includes an associated customer Identification (ID) and a respective accumulated point total. These point accumulations, similar to the common denominator player tracking points widely applied in current player tracking systems, can be applied toward potential complementaries and services offered by the casino establishment to the customers to encourage future play and consumer loyalty.

The system further includes a monitoring device 23 configured to monitor the betting activity of the plurality of customers at the one or more casino establishments 21, and a point accumulation device 28 adapted to accrue primary betting activity points for the customer accounts. For instance, when the system detects or is made aware of betting activity by the first customer, primary betting activity points are accumulated in the first customer account. Similarly, the primary betting activity points may be accumulated for the second customer account which relate to the betting activity of the second customer monitored at the one or more casino establishments. To further accumulate points, according to the present invention, sponsorship points can be accrued in the first customer account which are based upon the sponsorship of the second customer by the first customer.

Accordingly, this tracking system provides multi-level player tracking point accumulation. In the first customer account, the first customer may accumulate primary betting activity points based upon their own gaming activity and may accumulate sponsorship points which, for example, may be accrued one time when the second customer (sponsored by the first customer) enrolls in the player tracking program. In addition to the primary betting point accumulation, the first customer may accrue secondary betting activity points based upon the betting activity of the second customer. Such multi-level point accumulation will encourage current player tracking customers to enroll new customers into the plan.

Briefly, as will be described in greater detail below, the primary betting activity points, the secondary betting activity points, sponsorship points, etc. may all be equated to a common denominator player tracking points.

Referring to FIG. 1, a block diagram is provided which broadly illustrates the player tracking system 20 having an account manager device 22 provided as a central player tracking/accounting server 22. The player tracking/accounting server is typically configured to A) store player tracking account information relating to a player's previous game play, B) store player tracking account information relating to a player's historical frequency (E.g., the date and time spent) in the selected non-gaming sections of the casino, C) calculate primary betting activity points based on a player's game play that may be used as basis for providing rewards to the player. In accordance with the present invention, the accounting server 22 is further configured to D) calculate sponsorship points based on a player's sponsorship of another player's enrollment in the player tracking program, and E) calculate secondary betting activity points for a sponsor based on the sponsored player's game play.

A number of gaming machines, as shown in the block diagram, include player tracking interfaces 23 connected to servers providing player tracking services. These player tracking interfaces essentially provide the monitoring devices for monitoring gaming play by the customer, although such monitoring device may be provided through manual input as well. In casino establishment 21, gaming machines 25a-25f are connected, via the data collection unit (DCU) 26 to the computer system or player tracking/accounting server 22. The DCU 26, which for example may be connected to up to thirty-two (32) player tracking interfaces as part of a local network in a particular example, consolidates the information gathered from player tracking interfaces in gaming machines 25a-25f and forwards the information to the player tracking/accounting server 22.

By way of example, in gaming machine 25a of casino establishment 21 of FIG. 2, a player tracking interface 23 and slot machine interface board (SMIB) 27 of the player tracking system 20 are mounted within a main cabinet 30 of the gaming machine. In many types of gaming machines, the player tracking interface is mounted within a top box 31 positioned atop the gaming machine cabinet 30. Usually, player tracking interfaces, such as 23, and SMIBs, such as 27, are manufactured as separate units before installation into a gaming machine 25a.

Typically, the player tracking interface 23 includes three player tracking devices: a gaming activity card reader 32; a key pad 33; and a display 35, all mounted within the unit. These player tracking devices are used to input player tracking information that is needed to implement the player tracking program. The interface of the player tracking system 20 may be mounted in many different arrangements depending upon design constraints such as accessibility to the player, packaging constraints of a gaming machine and a configuration of a gaming machine. For instance, the player tracking devices may be mounted flush with a vertical surface in an upright gaming machine and may be mounted flush or at a slight angle upward with a horizontal in a flat top gaming machine.

The player tracking interface 23 communicates with the player tracking/accounting server via the SMIB 27, a main communication board 36 and the DCU 26. The SMIB 27 allows the player tracking interface 23 to gather information from the gaming machine 25a such as an amount a player has wagered during a game play session. This information may be used by a point calculation component 37 of the player tracking/accounting server 22 to calculate player tracking points for each player. The points are then accumulate in a point accumulation component 28, and then stored in a storage medium 38 of the server 22 for each customer account.

The player tracking interface 23 is usually connected to the master gaming controller 40 via a serial connection using a serial communication protocol. The serial connection between the SMIB 27 and the master gaming controller 40 may be through the main communication board 36 which may be integral with the SMIB 27 in one specific embodiment. The serial connection of the SMIB 27 may also be made through another intermediate device or through a direct connection to the master gaming controller 40. In general, communication between the various gaming devices is provided using wire connectors with proprietary communication protocols. As an example of a proprietary serial communication protocol, the master gaming controller 40 may employ a subset of the Slot Accounting System (SAS protocol) developed by International Game Technology of Reno, Nev. to communicate with the player tracking interface 23.

In one particular embodiment, by way of example, when a game player desires to play a game on a gaming machine and utilize player tracking system 20 available through the player tracking interface, a game player inserts their issued player tracking identification device 41, such as a magnetic striped card, into the card reader 32. Briefly, for current player tracking programs, the most common approach for providing identification information is to issue a magnetic-striped card storing the necessary identification information to each A player that wishes to participate in a given player tracking program. It will be appreciated, however, as will be better described below, that the issued player tracking identification device 41 may be wireless interfaces such as Radio Frequency (RF) enabled smart cards and/or wireless Personal Digital Assistants (PDA) which enable wireless communication with the player tracking/accounting server. Accordingly, wireless communication may be provided for the player tracking interface 23.

After the magnetic striped card has been so inserted, the player tracking interface 23 may detect this event and receive certain identification information contained on the card. For example, a player's name, address, social security number and player tracking account number encoded on the magnetic striped card, may be received by the player tracking interface 23. In general, a player must provide identification information of some type to utilize player tracking services available on a gaming machine.

Once the player has inserted her or his player tracking card into the gaming activity card reader 32, the player tracking interface 23 may command the touch screen display 35 to display the game player's name on the touch screen display 35 and also, may optionally display a message requesting the game player to validate their identity by entering an identification PIN code using a game service interface with an alpha-numeric key pad displayed on touch screen display 35 or through a player tracking input keypad. For example, the player may use their finger, a stylus or combinations thereof to enter their identification information using the touch screen sensor. Once the game player's identity has been validated, the player tracking information is relayed to the player tracking/accounting server 22.

Typically, the player tracking/accounting server 22 stores player tracking account records including the number of player tracking points previously accumulated by the player in the storage medium 38, such as a hard drive. Using this gaming activity data, the casino establishment may monitor their gaming activity for future promotions and customer service. Some player tracking systems, for example, incorporate management programs which update and calculate theoretical win profiles for each respective customer. These profiles are generally a {unction of estimated winnings from the betting activity of the customer at the casino establishment over a time period.

Details of player tracking interfaces with peripheral devices operated by a master gaming controller are described in co-pending U.S. patent application Ser. No. 09/838,033, filed Apr. 19, 2001, by Criss-Puskiewicz, et al, titled “Universal Player Tracking System,” which is incorporated herein in its entirety and for all purposes and co-pending U.S. patent application Ser. No. 09/642,192, filed Aug. 18, 2000, by LeMay, et al, titled “Gaming Machine Virtual Player Tracking Services,” which is incorporated herein in its entirety and for all purposes. Moreover, details of player tracking systems with wireless player tracking identification devices are described in co-pending U.S. patent application Ser. No.: 09/921,489, filed Aug. 3, 2001, by Hedrick, et al, titled “Player Tracking Communication Mechanisms in a Gaming Machine” which is incorporated herein in its entirety and for all purposes

In accordance with the present invention, when one customer (i.e., the first customer or first tier sponsor), already enrolled or participating, in a player tracking program, sponsors or encourages another customer (i.e., the second customer, second-tier sponsor or first-tier sponsoree) to enroll and participate in the Player Tracking Program, the first customer may be awarded sponsorship points in their customer account. This award of sponsorship points, will of course be based upon their sponsorship of the second customer.

The amount of such sponsorship points can be any preset, one-time amount, or may vary or be graduated depending upon the number of sponsorees the customer has encouraged to enroll. For example, the first customer (sponsor) may be eligible for 500 points for the first 1-10 customers (i.e., first-tier sponsorees) that they sponsor, and 750 points for the next 11-20 customers that they sponsor.

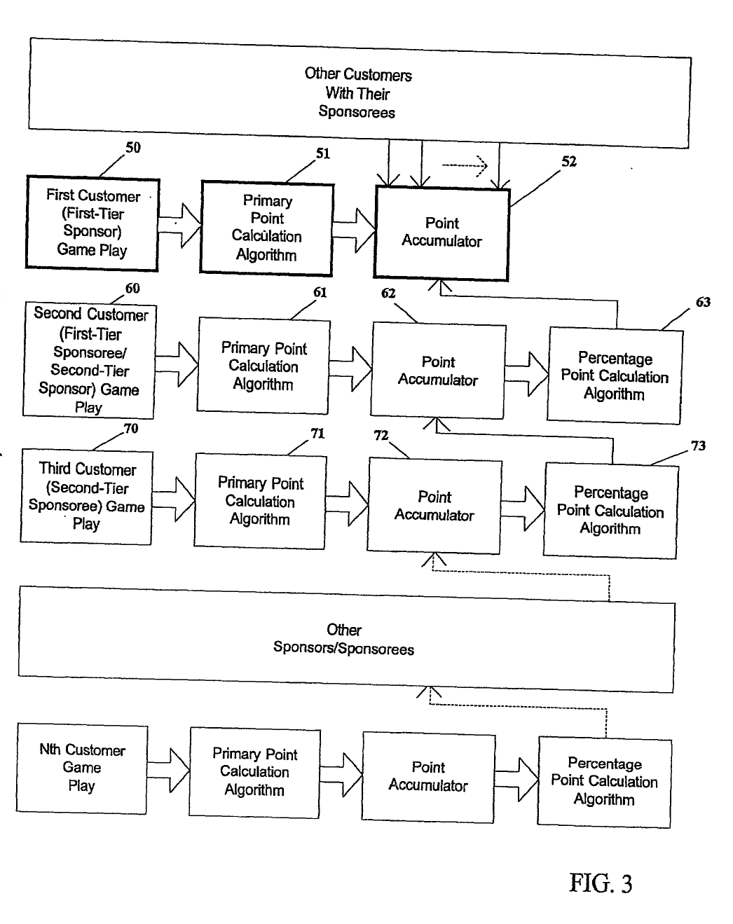

Moreover, the sponsor may be eligible for additional betting activity points based upon the gaming play of their sponsorees. Referring now to the flow diagram of FIG. 3, some examples of multi-lever player tracking point calculation are illustrated for betting activity. For instance, a first customer or sponsor whom is currently enrolled in the player tracking program may accumulate primary betting activity points for their respective account based upon their game play at 50.

Applying a point calculation algorithm, at 51, in the point calculation component of the accounting server 22, the primary betting activity points can be calculated factoring selected gaming data. Such factors include, for example, the average wager amount, the total time of monitored play, the player status of that player, or any customized factor deemed important by the casino management.

As mentioned, these primary betting activity points may be selected as, or converted into, some common denominator point system such as player tracking points. At 52, these points are transferred to the point accumulation component 28 of the accounting server 22 which accumulates the player tracking points corresponding to the first customer's account. These points may then be stored in the storage medium 38 of the accounting server 22 or the like for access where they are applied toward potential complementaries and services offered by the casino establishment to the customers to encourage future play and consumer loyalty. Further, similar to other player tracking systems, a theoretical win profile may be periodically calculated and updated for the first customer.

At 60 of FIG. 3, a second customer (i.e., the first-tier sponsoree) may commence gaming play which is detected and monitored by a corresponding player tracking interface 23. Similar to the first customer's account, the point calculation algorithm in the point calculation component 37 of the accounting server 22 (FIG. 2) is accessed, at 61, to calculate the corresponding primary betting activity points. Again, these primary betting activity points for the second customer can then be converted into the common denominator player tracking points which are transferred to the point accumulation component 28 at 62.

In accordance with the present invention, since the second customer (first-tier sponsoree) was sponsored by the first customer (first-tier sponsor), the first customer will be entitled to accrue secondary betting activity points based upon the primary betting activity point awarded to the second customer. In the accounting server 22, for instance, all first-tier sponsorees of a sponsor will be indexed as such so that secondary betting points will be properly awarded when a sponsoree accrues primary betting activity points.

In the example of FIG. 3, once the primary betting activity points are calculated at 61 for the second customer (first-tier sponsoree), the accounting server will award secondary betting points to the first customer (i.e., the first-tier sponsor). For instance, the accounting server 22 will calculate the secondary betting activity points for the first customer, at 63, based upon the primary betting activity points accrued for the second customer, at 61. The secondary betting activity points are then transferred to the point accumulation component 28 for point accumulation in the first customer's account, at 52.

Another algorithm in the point calculation component 37 of the accounting server 22, at 63, determines the amount of secondary betting activity points. As mentioned, these secondary points are based upon the amount of primary betting activity points awarded to the first customer. The algorithm applied to determine the secondary betting activity points may be a complex formulation or may be a simple percentage of the calculated primary betting activity points. For instance, the secondary betting activity points may be in the range of about 1% percent to about 10% of every primary betting activity point accrued. Preferably, this factor is about 5% percent, but it will be appreciated that this amount may be virtually any amount.

Briefly, it will be appreciated that while the present invention is being described in terms of primary betting activity points, secondary betting activity points, sponsorship points, etc., all these points may be represented in terms of or converted into the common denominator player tracking points.

In accordance with the present invention, two or more levels or tiers of player tracking point distribution may be provided, as well, should the second customer sponsor (i.e., a second-tier sponsor) their own customers (i.e., a third customer or second-tier sponsoree). Referring back to FIG. 3, monitored gaming play, at 70, by the third customer will result in primary betting activity points therefore, at 71, and will result in the accrual of secondary betting activity points for the second customer calculated, at 73, similar to the basis above mentioned. Moreover, according to the present invention, tertiary betting activity points can be awarded to the first customer (i.e., first tier-sponsor) based upon the second customer's (i.e., first-tier sponsoree) sponsorship of the third customer (i.e., second-tier sponsoree). In other words, the tertiary betting activity points can be awarded based upon either the primary betting activity point awarded to the third customer or the second betting activity point awarded to the second customer.

In the accounting server 22, all second-tier sponsorees of a first tier sponsor will be earmarked as such so that the secondary betting activity points can be properly awarded to the second-tier sponsor (e.g., second customer) and the tertiary betting activity points can be properly awarded to the first-tier sponsor (e.g., first customer) when the second tier sponsoree (e.g., third customer) accrues primary betting points. In this example for clarity, the second customer is a first-tier sponsoree of the first customer, and a second-tier sponsor of the third customer, while the third customer is effectively a first-tier sponsoree of the second customer, and a second-tier sponsoree of the first customer.

Referring back FIG. 3, at 71, and similar to the second customer, once the primary betting activity points are calculated by the point calculation component 37 for the third customer, the accounting server 22 will award secondary betting points to the second customer (i.e., the second-tier sponsor), at 72. Based upon these primary betting activity points of the third customer, the secondary betting activity points are calculated, at 73, and then transferred to the point accumulation component 28 for point accumulation in the second customer's account, at 72.

In accordance with this embodiment of the present invention, tertiary betting activity points are then calculated by the point calculation component 37, at 63, for the first customer (i.e., the first-tier sponsor). At 52, these points are transferred to the point accumulation component 28 for point accumulation in the first customer's account since the first customer is the first-tier sponsor of the second customer (i.e., second-tier sponsor/first-tier sponsoree). Such multi-level point distribution provides an added incentive for customers to promote enrollment and game play by their sponsorees, as well as their sponsoree's associates.

Similar to the first-tier sponsoree (e.g., the second customer), the algorithm in the point calculation component 37, at 63, determines the amount A of tertiary betting activity points that are to be awarded to the first-tier sponsor (e.g., the first customer), which essentially is based upon the amount of primary betting activity points awarded to the second-tier sponsoree (e.g., the third customer). The algorithm applied to determine the tertiary betting activity points may also be a complex formulation or may be a simple percentage of the calculated primary betting activity points of the third customer or of the calculated secondary betting activity points of the second customer. For instance, the tertiary betting activity points may also be in the range of about 1% percent to about 10% percent of every primary betting activity point accrued by the third customer.

Although the foregoing invention has been described in some detail for purposes of clarity of understanding, it will be apparent that certain changes and modifications may be practiced within the scope of the appended claims. For instance, while only three levels or tiers have been described, it is apparent from FIG. 3 that an unlimited number of tiered are possible. Further, while the gaming machines of this invention have been depicted as upright models having top box mounted on top of the main gaming machine cabinet, the use of gaming devices in accordance with this invention is not so limited.

What is claimed is:

1. A computer-implemented method for tracking the customer activity of a plurality of customers at one or more casino establishments, said method comprising:
creating a first customer account having a customer Identification (ID) associated with a first customer;
monitoring the betting activity of the first customer at the one or more casino establishments;
accruing primary betting activity points in the first customer account relating to the betting activity of the first customer monitored at the one or more casino establishments;
creating a second customer account having a customer Identification (ID) associated with a second customer, said second customer being sponsored by the first customer; and
accruing sponsorship points in the first customer account based upon the sponsorship of the second customer by the first customer; and
providing at least one of complementaries and services to the customers based upon their accumulated point total.

2. The method of claim 1, wherein
said betting activity points have a greater weighting than the sponsorship points in the accumulated point total.

3. The method of claim 1, further including:
monitoring the betting activity of the second customer at the one or more casino establishments;
accruing primary betting activity points in the second customer account relating to the primary betting activity of the second customer monitored at the one or more casino establishments; and
accruing secondary betting activity points in the first customer account relating to the primary betting activity points accrued in the second customer account.

4. The method of claim 3, wherein
the quantity of secondary betting activity points accrued in the first customer account are based upon the quantity of primary betting activity points accrued in the second customer account.

5. The method of claim 4, wherein
the secondary betting activity points accrued in the first customer account are proportional to the primary betting activity points accrued in the second customer account.

6. The method of claim 1, wherein
said monitoring the betting activity includes tracking the level of gaming play of the first customer.

7. The method of claim 6, further including:
periodically updating a theoretical win profile for the first customer as a function of estimated winnings from the betting activity of the customer at the casino establishment over a time period, and
storing the theoretical win profile in association with the first customer account.

8. The method of claim 3, further including:
creating a third customer account having a customer Identification (ID) associated with a third customer, said third customer being sponsored by the second customer;
accruing sponsorship points in the second customer account based upon the sponsorship of the third customer by the second customer; and
accruing sponsorship points in the first customer account based upon the sponsorship of the second customer by the first customer, and upon the sponsorship of the third customer by the second customer.

9. The method of claim 8, further including:
monitoring the betting activity of the third customer at the one or more casino establishments;
accruing primary betting activity points in the third customer account relating to the betting activity of the third customer monitored at the one or more casino establishments;
accruing secondary betting activity points in the second customer account relating to the primary betting activity points accrued in the third customer; and
accruing tertiary betting activity points in the first customer account relating to the secondary betting activity accrued in the second customer account.

10. The method of claim 9, wherein
the quantity of secondary betting activity points accrued in the first and second customer accounts are based upon the quantity of primary betting activity points accrued in the second and third customer accounts, respectively, and
the quantity of tertiary betting activity points accrued in the first customer account are based upon the quantity of secondary betting activity points accrued in the second customer account.

11. The method of claim 10, wherein
the quantity of secondary betting activity points accrued in the first and second customer accounts are proportional to the quantity of primary betting activity points accrued in the second and third customer accounts, respectively, and
the quantity of tertiary betting activity points accrued in the first customer account are proportional to the quantity of secondary betting activity points accrued in the second customer account.

12. A player tracking system for tracking the customer activity of a plurality of customers at one or more casino establishments comprising:
an account manager device having a first customer account associated with a first customer and a second customer account associated with a second customer, said second customer being sponsored by the first customer, each customer account having a respective customer Identification (ID) and a respective accumulated point total;
a monitoring device configured to monitor the betting activity of the plurality of customers at the one or more casino establishments;
a point accumulation device adapted to accrue primary betting activity points for the first customer account relating to the betting activity of the first customer monitored at the one or more casino establishments, and for the second customer account relating to the betting activity of the second customer monitored at the one or more casino establishments, said point accumulation device further configured to accrue sponsorship points in the first customer account based upon the sponsorship of the second customer by the first customer;
wherein to at least one of complementaries and services may be provided for the customers based upon their respective accumulated point total.

13. The tracking system according to claim 12, wherein
said betting activity points have a greater weighting than the sponsorship points in the accumulated point total.

14. The tracking system according to claim 12, further including:
monitoring the betting activity of the second customer at the one or more casino establishments;
accruing primary betting activity points in the second customer account relating to the primary betting activity of the second customer monitored at the one or more casino establishments; and
accruing secondary betting activity points in the first customer account relating to the primary betting activity points accrued in the second customer account.

15. The tracking system according to claim 14, wherein
the quantity of secondary betting activity points accrued in the first customer account are based upon the quantity of primary betting activity points accrued in the second customer account.

16. The tracking system according to claim 15, wherein
the secondary betting activity points accrued in the first customer account are proportional to the primary betting activity points accrued in the second customer account.

17. The tracking system according to claim 12, wherein
said monitoring the betting activity includes tracking the level of gaming play of the first customer.

18. The tracking system according to claim 17, further including:
periodically updating a theoretical win profile for the first customer as a function of estimated winnings from the betting activity of the customer at the casino establishment over a time period, and
storing the theoretical win profile in association with the first customer account.

19. The tracking system according to claim 14, further including:
creating a third customer account having a customer Identification (ID) associated with a third customer, said third customer being sponsored by the second customer;
accruing sponsorship points in the second customer account based upon the sponsorship of the third customer by the second customer; and
accruing sponsorship points in the first customer account based upon the sponsorship of the second customer by the first customer, and upon the sponsorship of the third customer by the second customer.

20. The tracking system according to claim 19, further including:
monitoring the betting activity of the third customer at the one or more casino establishments;
accruing primary betting activity points in the third customer account relating to the betting activity of the third customer monitored at the one or more casino establishments;
accruing secondary betting activity points in the second customer account relating to the primary betting activity points accrued in the third customer; and
accruing tertiary betting activity points in the first customer account relating to the secondary betting activity accrued in the second customer account.

21. The tracking system according to claim 20, wherein
the quantity of secondary betting activity points accrued in the first and second customer accounts are based upon the quantity of primary betting activity points accrued in the second and third customer accounts, respectively, and
the quantity of tertiary betting activity points accrued in the first customer account are based upon the quantity of secondary betting activity points accrued in the second customer account.

22. The tracking system according to claim 21, wherein
the quantity of secondary betting activity points accrued in the first and second customer accounts are proportional to the quantity of primary betting activity points accrued in the second and third customer accounts, respectively, and
the quantity of tertiary betting activity points accrued in the first customer account are proportional to the quantity of secondary betting activity points accrued in the second customer account.
